(19) United States
(12) Patent Application Publication
(10) Pub. No.: US 2026/0294743 A1
(43) Pub. Date: Oct. 1, 2026

(54) VIAL SUPPLY DEVICE, DRUG DISPENSING DEVICE, DRUG CHARGE AMOUNT INSPECTION DEVICE, DRUG-FILLED VIAL DISCHARGE DEVICE, FRAME PART ROTATION DEVICE FOR MAINTENANCE, AND VIAL-TYPE DRUG PREPARATION FACILITY INCLUDING SAME

(71) Applicant: JVM CO., LTD., Daegu (KR)

(72) Inventors: Dong Hwan LEE, Daegu (KR); Sang Wook KIM, Daegu (KR)

(73) Assignee: JVM CO., LTD., Daegu (KR)

(21) Appl. No.: 19/479,199

(22) PCT Filed: May 10, 2024
(86) PCT No.: PCT/KR2024/006308

§ 371 Date: Oct. 27, 2025

(30) Foreign Application Priority Data
May 10, 2023 (KR) 10-2023-0060508
Jun. 26, 2023 (KR) 10-2023-0081884
Jul. 25, 2023 (KR) 10-2023-0096646
Dec. 18, 2023 (KR) 10-2023-0184406
Dec. 18, 2023 (KR) 10-2023-0184407
Dec. 22, 2023 (KR) 10-2023-0189445
May 2, 2024 (KR) 10-2024-0058243
May 2, 2024 (KR) 10-2024-0058244
May 2, 2024 (KR) 10-2024-0058245

(51) Int. Cl. A61J 7/00; A61J 1/06; B65B 3/00

(52) U.S. Cl. CPC A61J 7/0076; B65B 3/006; A61J 1/065

(57) ABSTRACT

A vial supply device according to the present invention includes: a vial placing portion where a vial is placed in a lying state; a vial discharge portion moving the vial to a subsequent process for filling the vial with a drug; and a vial pressing portion pressing the vial placed on the vial placing portion to cause the vial to fall onto the vial discharge portion while in an upright state.

### TECHNICAL FIELD

The present invention relates to a vial supply device, a drug dispensing device, a drug fill amount inspection device, a drug-filled vial discharge device, a frame part rotation device for maintenance, and a vial-type drug preparation facility including the same.

### BACKGROUND ART

Generally, a drug preparation facility is a facility that allows a drug to be dispensed from a drug storage cassette having drugs stored therein according to drug dispensing information such as a so-called “prescription” and then be packaged with a specific packaging means.

Here, based on medical care systems such as medical laws of different countries, while some countries including South Korea allow the usage of facilities that package drugs in single doses using packaging paper made of materials such as a film or paper, certain countries do not allow drugs to be packaged in single doses.

Such countries allow vials, which refer to small container made of glass or plastic, to be filled with a plurality of drugs and provided to patients, and in this case, facilities that fill vials with appropriate amounts of drugs based on prescriptions are used.

In the case of the vial-type drug preparation facility, as disclosed in Korean Patent Publication No. 10-2010-0023797, in a state in which a plurality of vials are stored, a specific vial is moved to a site where a drug is dispensed, the vial is filled with the drug, and the vial filled with the drug is finally discharged.

However, the above conventional facility has a problem that inventory management of vials is not easy, a problem that vials may be oversupplied during supply of vials, a problem that preparation efficiency is decreased due to a vial not being accurately supplied at a specific point in time at which the vial should be supplied, a problem that the size of a vial being supplied is limited, a problem that certain drugs are not able to be accurately dispensed to vials, a problem that it is difficult to clearly determine whether a vial is filled with a correct amount of a drug, a problem that it is not possible to deal with a situation in which a vial filled with a drug is located in an abnormal state at an outlet, and a problem that maintenance is difficult.

Therefore, there is an urgent need for research on a vial-type drug preparation facility for addressing the above problems.

### DISCLOSURE

### Technical Problem

The present invention is directed to providing a vial supply device capable of supplying a vial that satisfies optimal conditions based on drug information contained in a drug dispensing request such as a prescription, thereby increasing user convenience and facilitating inventory management of vials.

The present invention is also directed to providing a vial supply device capable of preventing oversupply during supply of vials, ensuring smooth supply at a certain point in time at which a vial should be supplied, and allowing vials of various sizes to be supplied, thereby increasing the efficiency of supplying vials.

The present invention is also directed to providing a drug dispensing device capable of changing a dispensing principle according to characteristics of a drug that needs to be dispensed to a vial, thereby addressing a problem that a certain drug is not dispensed to a vial.

The present invention is also directed to providing a drug fill amount inspection device allowing whether a vial is filled with a correct amount of a drug to be inspected using a simple method, thereby preventing an overfilled or underfilled vial from being delivered to a patient.

The present invention is also directed to providing a drug-filled vial discharge device allowing, after a drug is dispensed and a vial is filled with the drug, the drug-filled vial to be located at an accurate position that enables the drug-filled vial to be withdrawn by a manager such as a pharmacist, thereby making it convenient to withdraw vials.

The present invention is also directed to providing a frame part rotation device for maintenance that enables maintenance of components storing drugs and dispensing the stored drugs.

The present invention is also directed to providing a vial-type drug preparation facility including the vial supply device, the drug dispensing device, the drug fill amount inspection device, the drug-filled vial discharge device, and/or the frame part rotation device for maintenance.

### Technical Solution

A vial supply device according to the present invention includes: a vial placing portion where a vial is placed in a lying state; a vial discharge portion moving the vial to a subsequent process for filling the vial with a drug; and a vial pressing portion pressing the vial placed on the vial placing portion to cause the vial to fall onto the vial discharge portion while in an upright state.

The vial placing portion of the vial supply device according to the present invention may have a first vial placing portion where a first vial is placed in a lying state after moving through a first path and a second vial placing portion where a second vial is placed in a lying state after moving through a second path, and the first vial placing portion and the second vial placing portion may be located so that a falling space is provided therebetween to allow the first vial or the second vial to fall in an upright state due to the vial pressing portion in a process of moving in the lying state.

The vial supply device according to the present invention may further include a space opening/closing portion for adjusting opening/closing of the falling space by moving.

The vial pressing portion of the vial supply device according to the present invention may have a first vial pressing portion for pressing the first vial placed on the first vial placing portion and a second vial pressing portion for pressing the second vial placed on the second vial placing portion, and movement ranges of the first vial pressing portion and the second vial pressing portion may be adjusted based on the lying states of the first vial and the second vial.

In a case in which an inlet of the first vial is located in a direction toward the second vial pressing portion on the first vial placing portion, the first vial pressing portion of the vial supply device according to the present invention may press the first vial so that the first vial is located on the second vial placing portion past the falling space in a state in which the falling space is closed by the space opening/closing portion.

The second vial pressing portion of the vial supply device according to the present invention may press the first vial and allow the first vial to be located upright in a normal state on the vial discharge portion through the falling space in a state in which the falling space is open.

In a case in which the inlet of the first vial is located in a direction toward the first vial pressing portion on the first vial placing portion, the first vial pressing portion of the vial supply device according to the present invention may press the first vial and allow the first vial to be located upright in the normal state on the vial discharge portion through the falling space in the state in which the falling space is open.

The vial supply device according to the present invention may further include: a first vial inlet detecting portion for detecting a direction of the inlet of the first vial placed on the first vial placing portion; and a second vial inlet detecting portion for detecting a direction of the inlet of the second vial placed on the second vial placing portion.

The vial supply device according to the present invention may further include a first vial uprightness maintaining portion and a second vial uprightness maintaining portion moved together with the first vial pressing portion and the second vial pressing portion, respectively, so that, in a process in which the first vial or the second vial falls onto the vial discharge portion through the falling space while in an upright state, a space in which falling is possible is defined and the upright state is maintained.

The vial discharge portion of the vial supply device according to the present invention may move to be close to the falling space and prevent the first vial or the second vial from lying in a case in which the first vial or the second vial falls and may move downward and return to its original position so that the first vial or the second vial moves to a subsequent process when falling of the first vial or the second vial is complete.

The vial supply device according to the present invention may further include at least one vial detecting portion for detecting at least one of a height and an area of a bottom surface of the first vial or the second vial when the first vial or the second vial is located in an upright state on the vial discharge portion.

### Advantageous Effects

With a vial supply device according to the present invention, by supplying a vial that satisfies certain conditions based on drug information contained in a drug dispensing request such as a prescription, waste of vials can be prevented, user convenience can be improved, and the efficiency of inventory management of vials can be increased.

In addition, with the vial supply device according to the present invention, oversupply can be prevented during supply of vials, smooth supply can be ensured at a certain point in time at which a vial should be supplied, and vials of various sizes can be supplied, thereby increasing the efficiency of supplying vials.

With a drug dispensing device according to the present invention, by controlling a principle of dispensing drugs from a space in which the drugs are stored according to characteristics of a drug that needs to be dispensed, a problem that a drug fails to be dispensed due to being caught at an inner wall in a process of being dispensed can be addressed, and the drug can be dispensed in an accurate number.

With a drug fill amount inspection device according to the present invention, by allowing whether a vial is filled with a correct amount of a drug to be inspected using a simple method, it is possible to prevent an overfilled or underfilled vial from being delivered to a patient.

With a drug-filled vial discharge device according to the present invention, by allowing, after a drug is dispensed and a vial is filled with the drug, the drug-filled vial to be located at an accurate position that enables the drug-filled vial to be withdrawn by a manager such as a pharmacist, the withdrawal of vials can be made convenient.

With a frame part rotation device for maintenance according to the present invention, by realizing optimization of door rotation, the maintenance of components storing drugs and dispensing the stored drugs can be made convenient.

With a vial-type drug preparation facility according to the present invention, by including the vial supply device, the drug dispensing device, the drug fill amount inspection device, the drug-filled vial discharge device, and/or the frame part rotation device for maintenance, a drug can be accurately added in a certain number to a specific vial based on a drug dispensing request such as a prescription, and the vial can be finally handed over to a manager.

### DESCRIPTION OF DRAWINGS

FIG. 1 is a view illustrating an overall exterior of a vial-type drug preparation facility according to the present invention.

FIG. 2 is a view of the inside of the vial-type drug preparation facility according to the present invention that is viewed from the rear.

FIG. 3 is a block diagram for describing the vial-type drug preparation facility according to the present invention.

FIG. 4 is a view illustrating a vial supply device according to the present invention.

FIGS. 5 and 6 are views for describing a vial storage portion and a vial supply portion provided in the vial supply device according to the present invention.

FIGS. 7 and 8 are views for describing a buffer detecting portion provided in the vial supply device according to the present invention.

FIGS. 9 to 13 are views for describing a process in which a vial is placed in a first placing state on a vial placing portion provided in the vial supply device according to the present invention and then moved to a vial discharge portion.

FIGS. 14 to 17 are views for describing a process in which a vial is placed in a second placing state on the vial placing portion provided in the vial supply device according to the present invention and then moved to the vial discharge portion.

FIG. 18 is a view for describing a drug dispensing device according to the present invention.

FIGS. 19 and 20 are views for describing a drug delivering portion provided in the drug dispensing device according to the present invention.

FIG. 21 is a view for describing an operating principle of an opening/closing portion and a hitting portion due to a vial moving portion provided in the drug dispensing device according to the present invention.

FIG. 22 is a view for describing a drug fill amount inspection device according to the present invention.

FIG. 23 is a view for describing a labeling device and a drug-filled vial discharge device according to the present invention.

FIGS. 24 and 25 are views for describing a detecting portion provided in the drug-filled vial discharge device according to the present invention.

FIG. 26 is a view for describing a frame part rotation device for maintenance according to the present invention.

FIGS. 27 and 28 are views for describing a rotating operation of a mounting frame part provided in the frame part rotation device for maintenance according to the present invention.

FIG. 29 is a view for describing a coupling relationship between a first catching portion and a first protruding portion provided in the frame part rotation device for maintenance according to the present invention.

FIGS. 30 and 31 are views for describing a coupling relationship between a second catching portion and a second protruding portion provided in the frame part rotation device for maintenance according to the present invention.

### BEST MODE OF THE INVENTION

A vial supply device according to the present invention includes: a vial placing portion where a vial is placed in a lying state; a vial discharge portion moving the vial to a subsequent process for filling the vial with a drug; and a vial pressing portion pressing the vial placed on the vial placing portion to cause the vial to fall onto the vial discharge portion while in an upright state.

### Modes of the Invention

Hereinafter, specific embodiments of the present invention will be described in detail with reference to the accompanying drawings. However, the spirit of the present invention is not limited to the embodiments presented herein, and other less advanced inventions or other embodiments belonging to the scope of the spirit of the present invention may be easily proposed by adding other components, changing components, or omitting components within the scope of the same spirit by those of ordinary skill in the art who understand the spirit of the present invention, and such inventions or embodiments also belong to the scope of the spirit of the present invention.

In addition, components with the same functions within the scope of the same spirit shown in the drawings of each embodiment will be described using the same reference numerals.

### 1. Vial-Type Drug Preparation Facility

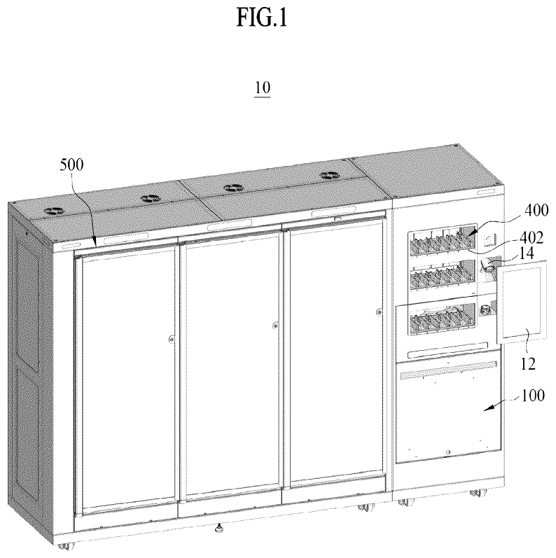

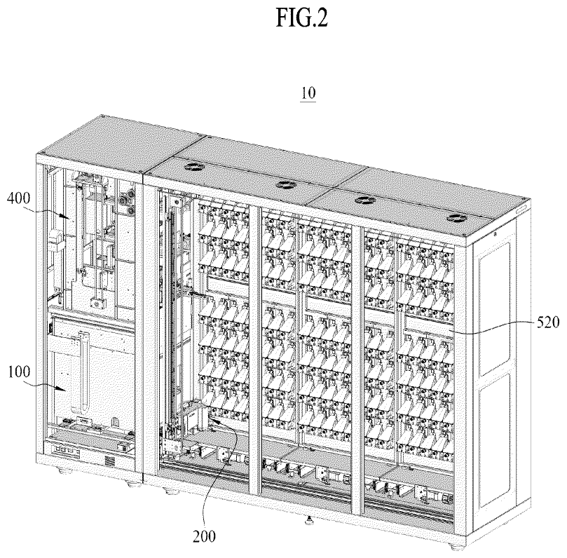

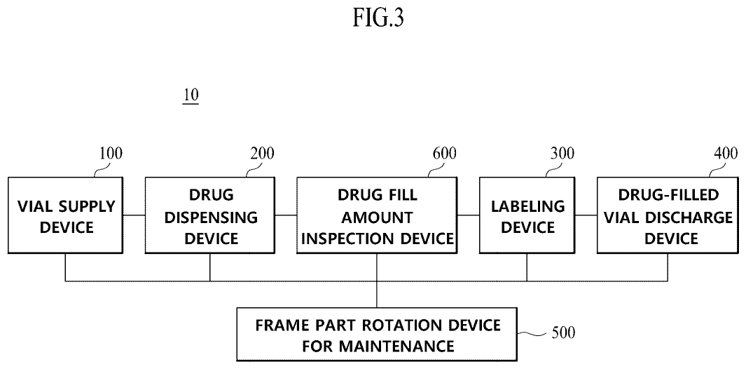

FIG. 1 is a view illustrating an overall exterior of a vial-type drug preparation facility according to the present invention, FIG. 2 is a view of the inside of the vial-type drug preparation facility according to the present invention that is viewed from the rear, and FIG. 3 is a block diagram for describing the vial-type drug preparation facility according to the present invention.

Referring to FIGS. 1 to 3, a vial-type drug preparation facility 10 according to the present invention may be a preparation facility in which a specific vial is selected among a plurality of vials based on a drug dispensing request (for example, a prescription of a patient), for the selected vial to be filled with a drug, the selected vial is automatically moved to a position where dispensing of a drug is possible and is filled with the drug, information necessary to inspect a fill amount of the drug is obtained, a label on which information related to the drug dispensing request is printed is attached to the vial, and the vial is automatically moved to a position where withdrawal by a manager is possible.

Here, a vial may refer to a small container made of glass or plastic.

The manager may check and/or input the information related to the drug dispensing request through a display 12 and may recognize a site where the vial filled with the drug due to the drug dispensing request is finally located through a display portion 402 made of light emitting diodes (LEDs) or the like, and in this way, the manager may withdraw the vial filled with the drug, may check the drug by visual inspection, may check the information printed on the label through a scanner 14, may check an image of the vial filled with the drug, and then may couple a cap to the vial and hand over the vial to a patient.

Here, in the vial-type drug preparation facility 10 according to the present invention, the process in which the specific vial is selected among the plurality of vials based on the drug dispensing request may be performed by a vial supply device 100.

In addition, the process in which the vial is automatically moved to the position where dispensing of the drug is possible and is filled with the drug may be performed by a drug dispensing device 200.

In addition, the process of obtaining the image of the vial filled with the drug may be performed by a drug fill amount inspection device 600.

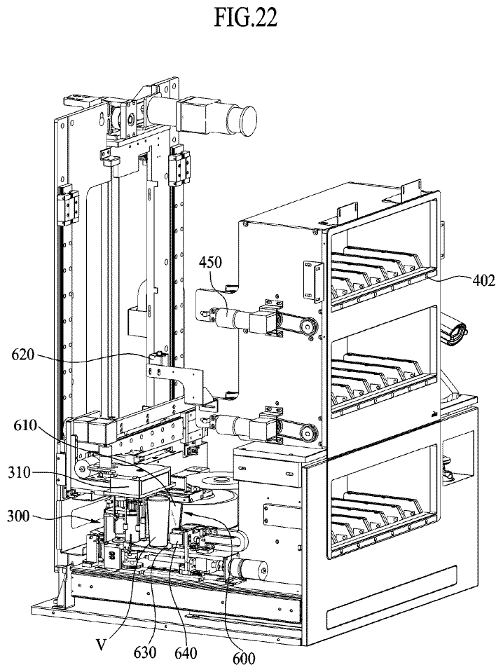

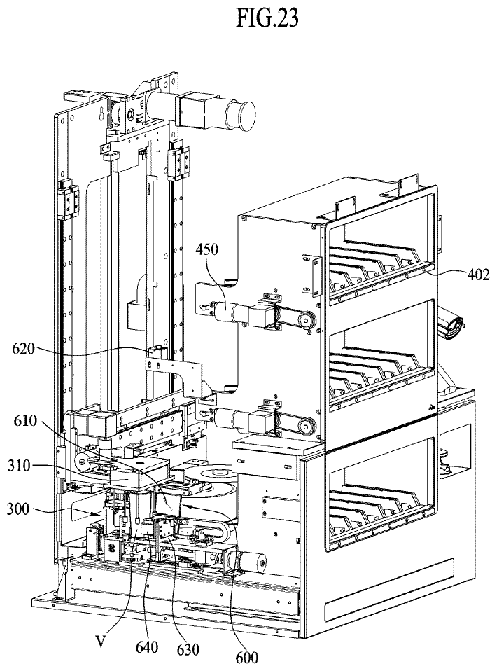

In addition, the process in which the label on which the information related to the drug dispensing request is printed is attached to an outer surface of the vial filled with the drug may be performed by a labeling device 300 (see FIGS. 22 and 23).

In addition, the process in which the vial filled with the drug is moved to the position where withdrawal by the manager is possible may be performed by a drug-filled vial discharge device 400.

Meanwhile, the vial-type drug preparation facility 10 according to the present invention may include a frame part rotation device for maintenance 500 that is a device enabling maintenance of components storing drugs and dispensing the stored drugs.

The vial supply device 100, the drug dispensing device 200, the drug fill amount inspection device 600, the drug-filled vial discharge device 400, and the frame part rotation device for maintenance 500 will be described in detail below.

### 2. Vial Supply Device

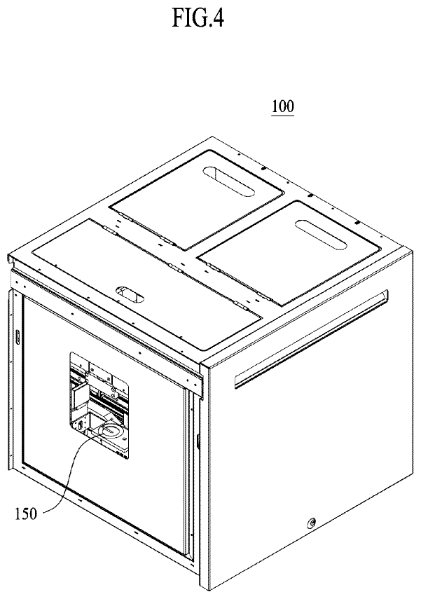

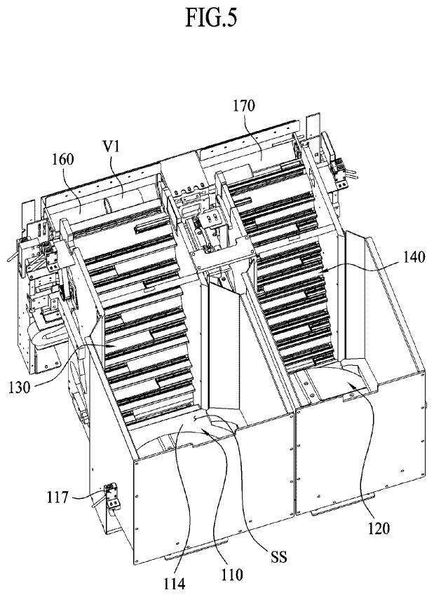

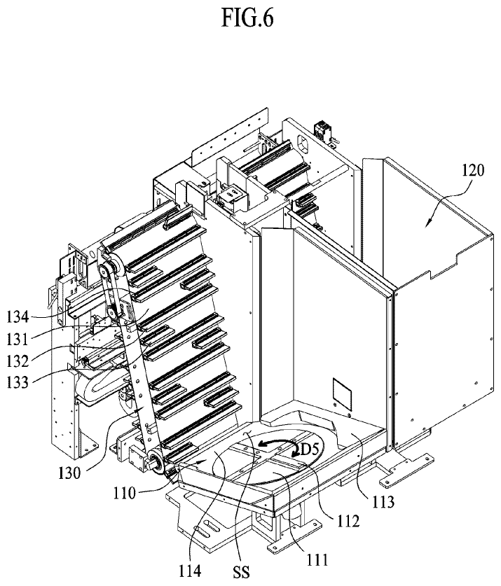

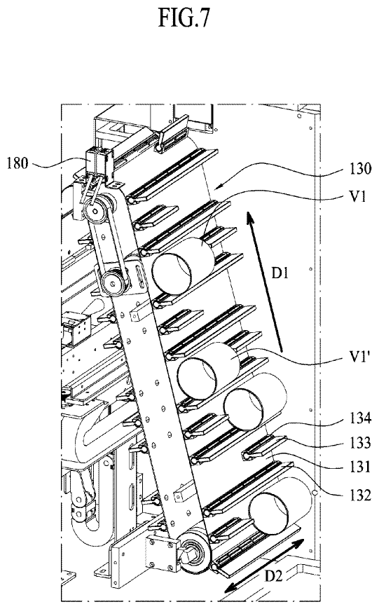

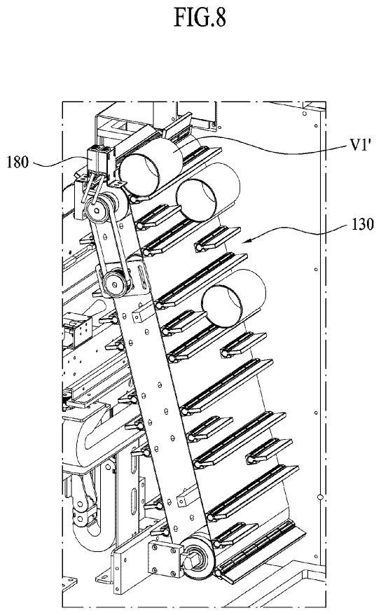

FIG. 4 is a view illustrating a vial supply device according to the present invention, FIGS. 5 and 6 are views for describing a vial storage portion and a vial supply portion provided in the vial supply device according to the present invention, and FIGS. 7 and 8 are views for describing a buffer detecting portion provided in the vial supply device according to the present invention.

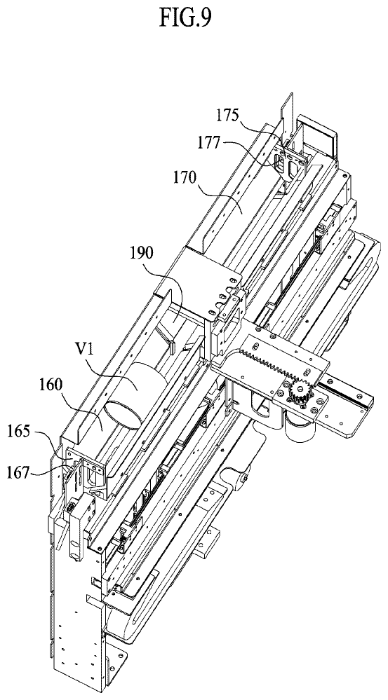

In addition, FIGS. 9 to 13 are views for describing a process in which a vial is placed in a first placing state on a vial placing portion provided in the vial supply device according to the present invention and then moved to a vial discharge portion.

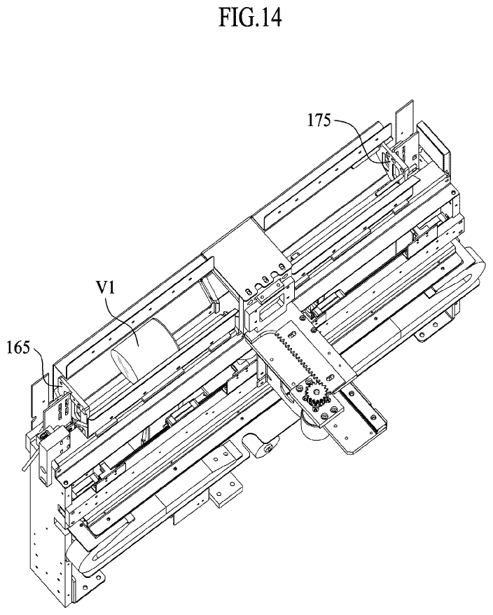

In addition, FIGS. 14 to 17 are views for describing a process in which a vial is placed in a second placing state on the vial placing portion provided in the vial supply device according to the present invention and then moved to the vial discharge portion.

Referring to FIGS. 4 to 17, the vial supply device 100 may be a device that allows a specific vial to be supplied based on drug information contained in a drug dispensing request such as a prescription in a state in which two or more types of vials each having a predetermined volume are stored.

The vial supply device 100 may include vial storage portions 110 and 120, vial supply portions 130 and 140, a vial discharge portion 150, and a controller (not illustrated) for controlling the overall operations or the like of the components.

The vial storage portions 110 and 120 may include a first vial storage portion 110 and a second vial storage portion 120, and the vial supply portions 130 and 140 may include a first vial supply portion 130 and a second vial supply portion 140.

The first vial storage portion 110 may be a space in which first vials V1 each having a first volume can be stored, and the second vial storage portion 120 may be a space in which second vials each having a second volume smaller than the first volume can be stored.

The first vials V1 and the second vials are stored in a random or disordered state in the first vial storage portion 110 and the second vial storage portion 120, respectively.

The first vial storage portion 110 and the second vial storage portion 120 may have first bottom portions 111 and 112 and a second bottom portion, respectively, that are state-changeable.

The first bottom portions 111 and 112 may allow the randomly-stored first vials V1 to be movable toward the first vial supply portion 130, and the second bottom portion may allow the randomly-stored second vials to be movable toward the second vial supply portion 140.

The first vial supply portion 130 may be a type of driving belt that is provided in the first vial storage portion 110 and allows the first vials V1 stored in a random state in the first vial storage portion 110 to be moved one by one to a first vial placing portion 160.

The first vial supply portion 130 may be disposed in an upwardly inclined state and may have a first belt portion 131 and first protruding partition walls 132 and 133 that allow the first vials V1 to be supported in a lying state and move upward.

A separation distance between the first protruding partition walls 132 and 133 that is based on a direction D1 in which the first vials V1 move upward may be adjusted according to the size of the first vials V1 stored in the first vial storage portion 110.

The first protruding partition walls 132 and 133 may be detachably mounted in a sliding manner on a first partition wall mounting portion 134 mounted on the first belt portion 131, but the present invention is not necessarily limited thereto.

The first protruding partition walls 132 and 133 may include first main protruding partition walls 132 and first auxiliary protruding partition walls 133.

The first main protruding partition walls 132 may be located upward and downward based on the direction D1 in which the first vials V1 move upward, and the first auxiliary protruding partition walls 133 may be provided between the first main protruding partition walls 132 and may define a width of the first vials V1 supported in a lying state in a horizontal direction D2.

The first auxiliary protruding partition walls 133 may be provided with a predetermined width in the horizontal direction D2 so that a single first vial V1 is located between the first main protruding partition walls 132 in the horizontal direction D2 or may be omitted depending on the width of the first vials V1 in a lying state in the horizontal direction D2.

The first auxiliary protruding partition walls 133 may be provided so as to be offset to one side or the other side in the horizontal direction D2 and may be alternately provided at one side and the other side in the horizontal direction D2.

Such an arrangement state of the first auxiliary protruding partition walls 133 is for allowing the first vials V1 randomly stored in the first vial storage portion 110 to be efficiently located between the first main protruding partition walls 132 and is an optimal arrangement state that takes into consideration the characteristic that the first vials V1 are randomly stored.

Meanwhile, the first vials V1 randomly stored in the first vial storage portion 110 may be efficiently supplied to the first vial supply portion 130 due to the first bottom portions 111 and 112 described above.

The first bottom portions 111 and 112 may be disposed to be inclined downward toward the first vial supply portion 130 and may have a first rotating portion 111 provided to be rotatable and formed in a substantially circular plate shape and a first protruding pressing portion 112 mounted on the first rotating portion 111 and pressing the first vials V1 in a circumferential direction D5 during rotation of the first rotating portion 111.

When the first rotating portion 111 rotates, the first vials V1 are pushed outward in the circumferential direction D5 due to being pressed by the first protruding pressing portion 112, and thus the first vials V1 move toward the first vial supply portion 130 and are efficiently inserted between the first main protruding partition walls 132.

A first inclined portion 113 formed to be inclined downward toward the first rotating portion 111 may be located around the first rotating portion 111, and the first vials V1 are naturally guided onto the first rotating portion 111 due to the first inclined portion 113.

Meanwhile, the first bottom portions 111 and 112 may be rotatably mounted on a first fixing support portion 114 supporting the rotation of the first rotating portion 111.

Here, the first rotating portion 111 may be provided with a diameter that does not allow the first vial V1 to be located in an upright state on an area SS exposed to the outside of the first rotating portion 111 among areas of the first fixing support portion 114 and that enables rotation without interference with other components, and may be mounted on the first fixing support portion 114.

Therefore, since the first vials V1 stored in a random or disordered manner can all be moved toward the first vial supply portion 130, without exceptions, due to being affected by the first rotating portion 111, the efficiency of supplying the first vials V1 is improved.

Meanwhile, since the principle of the second vials stored in the second vial storage portion 120 being moved through the second vial supply portion 140 is substantially the same as the above-described principle of the first vials V1 being moved through the first vial supply portion 130, detailed description thereof will be omitted.

After the first vials V1 stored in the first vial storage portion 110 are moved to the first vial supply portion 130 as illustrated in FIGS. 7 and 8, when the first vial V1 is placed on the first vial placing portion 160 as illustrated in FIG. 9, whether the operation of the first vial supply portion 130 continues may be controlled by the controller so that subsequent first vials V1′ that should be continuously supplied afterwards can be supplied to the first vial placing portion 160 at a specific point in time that takes into consideration the efficiency of supply.

The operation of the first vial supply portion 130 may continue until the subsequent first vial V1′ that should be supplied afterwards is located at a specific position as illustrated in FIG. 8.

The specific position may be set in accordance with a user's intention and may be a final upward movement position, for example.

Here, the final upward movement position may be a position at which the subsequent first vial V1′ is about to fall due to the operation of the first vial supply portion 130.

When the subsequent first vial V1′ is located at the final upward movement position, the subsequent first vial V1′ at the final upward movement position is detected by a first buffer detecting portion 180.

The first buffer detecting portion 180 may be a type of photosensor that is for, when the first vial V1 moves upward due to the first vial supply portion 130, moves away from the first vial supply portion 130, and then is supplied to the first vial placing portion 160, which is a space for moving to the vial discharge portion 150, in order to move to the vial discharge portion 150, allowing whether the first vial supply portion 130 operates to be controlled by the controller so that the subsequent first vial V1′ is supplied to the space at an optimal specific point in time at which the subsequent first vial V1′ can be filled with a drug.

When the presence of the subsequent first vial V1′ at the final upward movement position is detected by the first buffer detecting portion 180, the operation of the first vial supply portion 130 may stop as illustrated in FIG. 8 due to the controller, and as a result, the subsequent first vial V1′ is located at the final upward movement position for a predetermined amount of time, and it is possible to prevent a problem in which a plurality of first vials are simultaneously supplied to the first vial placing portion 160.

As described above, the first buffer detecting portion 180 may be a sensor that detects whether the first vial V1 is present at a specific position on the first vial supply portion 130 so that the first vials V1 stored in the first vial storage portion 110 are sequentially supplied with a predetermined time difference onto the vial discharge portion 150 after being placed on the first vial supply portion 130.

In addition, the controller may control an operational state of the first vial supply portion 130 based on a result detected by the first buffer detecting portion 180 so that efficient supply of the first vials V1 is ensured.

That is, the operation of the first vial supply portion 130 may be stopped when, after the first vials V1 are supplied onto the vial discharge portion 150, it is detected by the first buffer detecting portion 180 that the subsequent first vial V1′ that should be supplied to the vial discharge portion 150 is present at the specific position.

At this time, the controller may also stop the rotating operation of the first rotating portion 111 of the first bottom portions 111 and 112 while stopping the operation of the first vial supply portion 130.

Meanwhile, the controller may increase an operational speed of the first vial supply portion 130 when it is detected by the first buffer detecting portion 180 that the first vial V1 is not present at the specific position for a predetermined first amount of time after the first vial supply portion 130 is operated.

In addition, the controller may increase an operational speed of the first rotating portion 111 or change a rotating direction of the first rotating portion 111 when it is detected by the first buffer detecting portion 180 that the first vial V1 is not present at the specific position for the predetermined first amount of time after the first vial supply portion 130 is operated.

For example, in the vial supply device 100 according to the present invention, when the first vial V1 is placed on the first vial placing portion 160 as illustrated in FIG. 9, an optimal time at which the subsequent first vial V1′ should be placed on the first vial placing portion 160 may be set in consideration of a subsequent process time including a process in which the first vial V1 is filled with a drug.

For the subsequent first vial V1′ to be placed on the first vial placing portion 160 at the optimal time, the first vial supply portion 130 should be operated, and the subsequent first vial V1′ should be located at the specific position within a predetermined standby time.

The more the time at which the subsequent first vial V1′ is located at the specific position is past the predetermined standby time, the more the supply of the subsequent first vial V1′ is delayed and the process efficiency is decreased.

For the above reason, in the present invention, when it is detected by the first buffer detecting portion 180 that the subsequent first vial V1′ is not present at the specific position for the predetermined first amount of time in consideration of the predetermined standby time, the operational speed of the first vial supply portion 130 is increased or the operational state of the first rotating portion 111 is changed in order to speed up the supply of the subsequent first vial V1′.

In addition, the above changes in the operational speed and the operational state may identically apply even during initial supply of the first vial V1.

Meanwhile, since the principle of the second vials moving to the second vial supply portion 140, the principle of the second vials falling from the second vial supply portion 140 and being placed on a second vial placing portion 170, and the principle of changing the operational speed of the second vial supply portion 140 are the same as the above-described principles related to the first vials V1, detailed description thereof will be omitted.

A process in which the first vial V1 becomes upright and is located on the vial discharge portion 150 will be described in detail below with the first vial V1 as an example, but it should be noted that the description identically applies also to the second vial.

When the first vial V1 moves upward due to the first vial supply portion 130, the first vial V1 falls from the first vial supply portion 130 and is placed on the first vial placing portion 160 as illustrated in FIG. 9, and after the state of the first vial V1 is changed to an upright state due to a first vial pressing portion 165, the first vial V1 is located on the vial discharge portion 150.

The vial placing portions 160 and 170 may include the first vial placing portion 160 and the second vial placing portion 170.

The first vial placing portion 160 may be a component for allowing the first vial V1 to be placed in a lying state, and the vial discharge portion 150 may be a component for allowing the first vial V1 to move to a subsequent process for filling the first vial V1 with a drug.

The vial pressing portion 165 and a vial pressing portion 175 may be components that press the vials placed on the vial placing portions 160 and 170 to cause the vials to fall onto the vial discharge portion 150 while in an upright state.

The first vial placing portion 160 may be a component for allowing the first vial V1 stored in the first vial storage portion 110 to be placed in a lying state after moving through a first path through which the first vial V1 is moved by the first vial supply portion 130.

In addition, the second vial placing portion 170 may be a component for allowing the second vial stored in the second vial storage portion 120 to be placed in a lying state after moving through a second path through which the second vial is moved by the second vial supply portion 140.

The first vial placing portion 160 and the second vial placing portion 170 may be located to be collinear and may be located so that a falling space S1 is provided therebetween to allow the first vial V1 or the second vial to fall in an upright state due to the vial pressing portion 165 or 175 in a process of moving in the lying state.

The opening/closing of the falling space S1 may be adjusted by movement of a space opening/closing portion 190, and the movement of the space opening/closing portion 190 is adjusted based on the lying state of the first vial V1 or the second vial.

The vial pressing portions 165 and 175 may have the first vial pressing portion 165 for pressing the first vial V1 placed on the first vial placing portion 160 and a second vial pressing portion 175 for pressing the second vial placed on the second vial placing portion 170.

Here, the movement range of the first vial pressing portion 165 may be adjusted based on the lying state of the first vial V1, and the movement range of the second vial pressing portion 175 may be adjusted based on the lying state of the second vial.

The operations of the first vial pressing portion 165 and the second vial pressing portion 175 according to the state in which the first vial V1 is lying on the first vial placing portion 160 will be described in detail below, but it should be noted that the description may identically apply also to the second vial.

When the first vial V1 is placed in the lying state on the first vial placing portion 160, two different cases may occur.

The first case is where an inlet of the first vial V1 is located toward the first vial pressing portion 165 as illustrated in FIG. 9, and the second case is where the inlet of the first vial V1 is located toward the second vial pressing portion 175 as illustrated in FIG. 14.

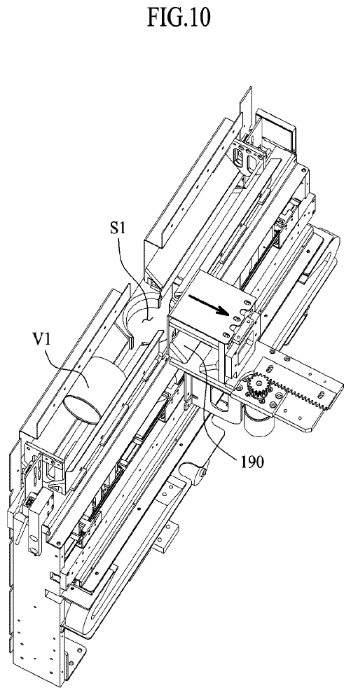

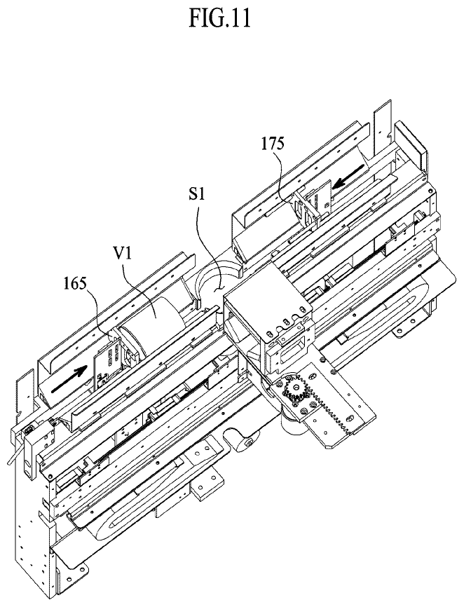

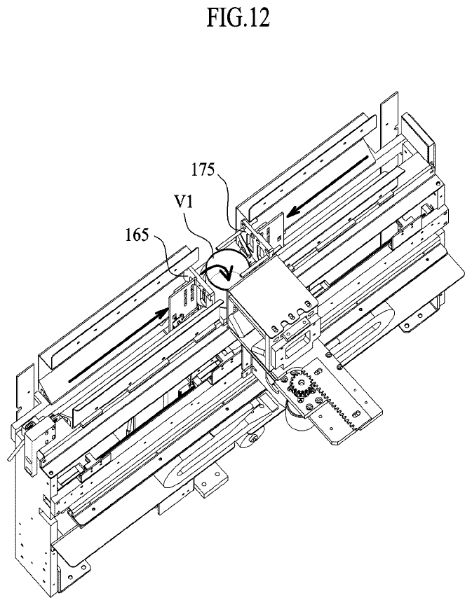

First, in the first case, the space opening/closing portion 190 may move backward and open the falling space S1 as illustrated in FIG. 10, and the first vial pressing portion 165 may, in the state in which the falling space S1 is open, press the first vial V1 and allow the first vial V1 to be located upright on the vial discharge portion 150 in a normal state, in which an inlet portion of the first vial V1 faces upward, through the falling space S1 as illustrated in FIGS. 11 and 12.

In other words, the first vial pressing portion 165 presses the inlet portion of the first vial V1 by moving, and at this time, the first vial V1 naturally enters the falling space S1 in a process of being moved and stands upright in the normal state.

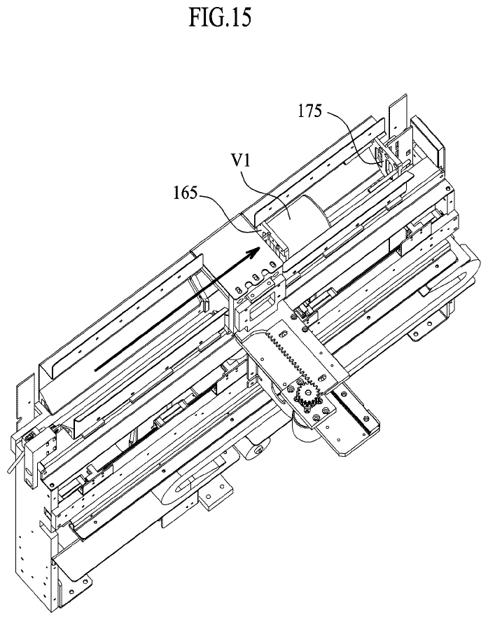

In the second case, the space opening/closing portion 190 may move forward and close the falling space S1 as illustrated in FIG. 14, and the first vial pressing portion 165 may, in the state in which the falling space S1 is closed, press the first vial V1 and allow the first vial V1 to be located on the second vial placing portion 170 past the falling space S1 as illustrated in FIG. 15.

Here, closing of the falling space S1 may be a concept that includes not only a case in which the falling space S1 completely disappears but also a case in which the size of the falling space S1 is reduced and the first vial V1 or the second vial is not able to pass therethrough.

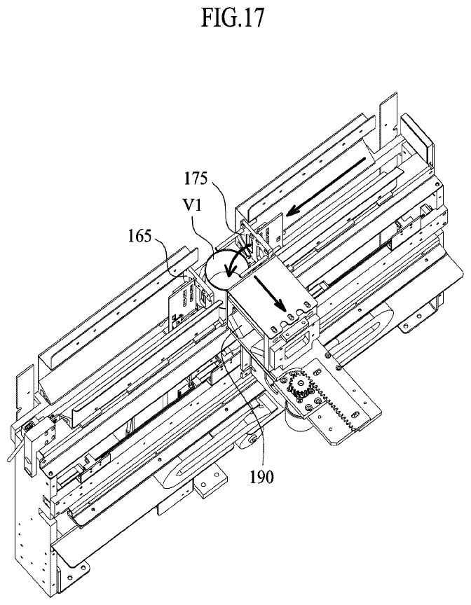

When the first vial V1 is located on the second vial placing portion 170 due to the first vial pressing portion 165, the space opening/closing portion 190 may move backward and open the falling space S1 as illustrated in FIG. 17, and the second vial pressing portion 175 may press the first vial V1 and allow the first vial V1 to be located upright on the vial discharge portion 150 in the normal state through the falling space S1.

The vial supply device 100 according to the present invention may include a first vial inlet detecting portion 167 for detecting a direction of the inlet of the first vial V1 placed on the first vial placing portion 160 and a second vial inlet detecting portion 177 for detecting a direction of the inlet of the second vial placed on the second vial placing portion 170.

The first vial inlet detecting portion 167 and the second vial inlet detecting portion 177 may each be a type of photosensor, but the present invention is not necessarily limited thereto.

The above-described operations of the first vial pressing portion 165 and the second vial pressing portion 175 are determined based on results detected by the first vial inlet detecting portion 167 and the second vial inlet detecting portion 177.

Meanwhile, the vial supply device 100 according to the present invention may include a first vial uprightness maintaining portion 169 and a second vial uprightness maintaining portion 179 moved together with the first vial pressing portion 165 and the second vial pressing portion 175, respectively.

In a process in which the first vial V1 or the second vial falls onto the vial discharge portion 150 while in an upright state through the falling space S1 due to the first vial pressing portion 165 or the second vial pressing portion 175, the first vial uprightness maintaining portion 169 and the second vial uprightness maintaining portion 179 may define a space in which falling is possible and allow the first vial V1 or the second vial to maintain the upright state.

Specifically, in the above-described first case, when the first vial V1 moves due to the movement of the first vial pressing portion 165 as illustrated in FIG. 11, the second vial pressing portion 175 also moves, and as a result, the first vial uprightness maintaining portion 169 and the second vial uprightness maintaining portion 179 also simultaneously move.

Here, the movement ranges of the first vial pressing portion 165 and the second vial pressing portion 175 may correspond to ranges that simultaneously allow the first vial V1 to fall through the falling space S1 and allow the first vial uprightness maintaining portion 169 and the second vial uprightness maintaining portion 179 to define the space in which falling is possible at a lower portion of the falling space S1.

Of course, it is obvious that the space in which falling is possible is within a range in which a vial, which is a target to fall, can be accommodated and can be prevented from lying.

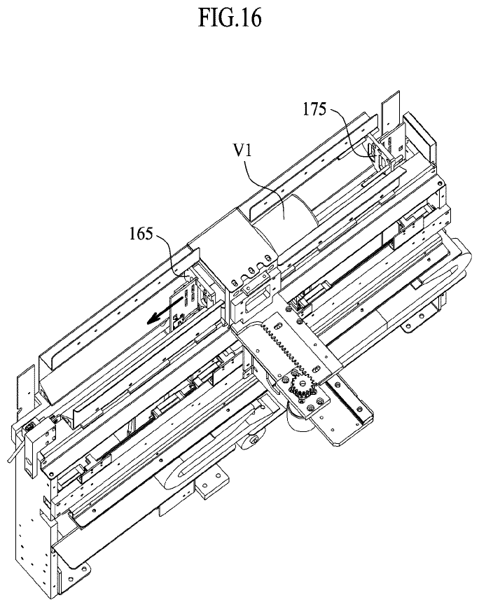

In the above-described second case, the first vial pressing portion 165 moves so that the first vial V1 is located on the second vial placing portion 170 past the falling space S1 as illustrated in FIG. 15 and then moves backward and stops at a predetermined position as illustrated in FIGS. 16 and 17, and the second vial pressing portion 175 moves to allow the first vial V1 to fall through the falling space S1.

Here, the movement ranges of the first vial pressing portion 165 and the second vial pressing portion 175 may be the same as in the first case.

When the first vial V1 is placed in an upright state on the vial discharge portion 150 as described above, the first vial pressing portion 165 and the second vial pressing portion 175 return to their original positions.

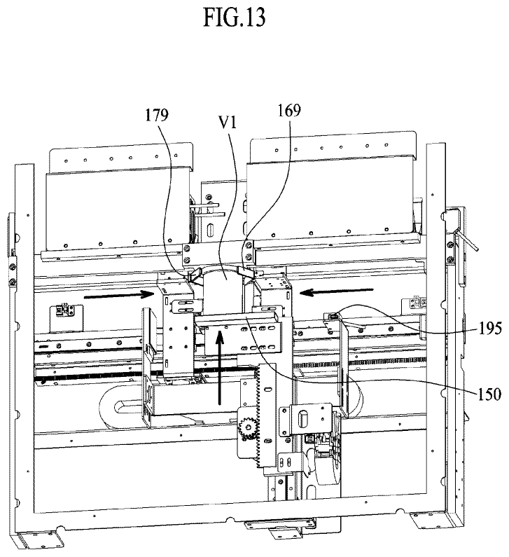

In a case in which the first vial V1 falls through the falling space S1, the vial discharge portion 150 may move upward as illustrated in FIG. 13.

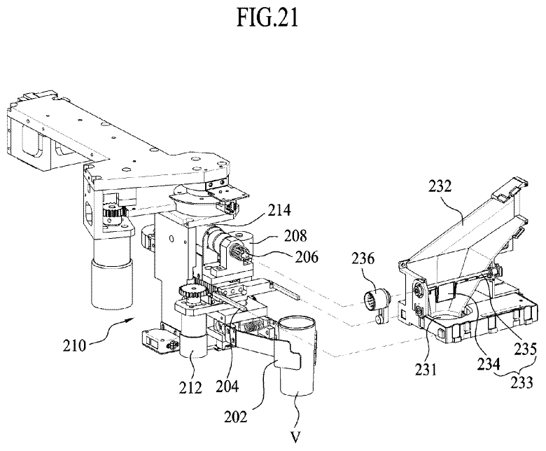

In the case in which the first vial V1 falls, the vial discharge portion 150 may move to be close to the falling space S1 and may prevent the first vial V1 from lying in the process of falling, and when the first vial V1 becoming upright in the normal state is complete, the vial discharge portion 150 may return to its original position, and afterwards, the first vial V1 may be gripped by a grip portion 202 (see FIG. 21) and may be moved to a subsequent process for filling the first vial V1 with a drug.

Meanwhile, when the first vial V1 is located in an upright state on the vial discharge portion 150, at least one of a height and an area of a bottom surface of the first vial V1 may be detected by at least one vial detecting portion.

For example, the vial detecting portion may include at least one height detecting portion 195 that can detect the height of the first vial V1 and at least one bottom detecting portion (not illustrated) that can detect the area of the bottom surface of the first vial V1.

The height detecting portion 195 may be provided as a plurality of height detecting portions 195 disposed in a height direction, and the bottom detecting portion may be provided as a plurality of bottom detecting portions disposed in a radial direction on a bottom surface of the vial discharge portion 150.

Therefore, whether a vial has been supplied and is located on the vial discharge portion 150 can be accurately determined based on the results related to the height and the area of the bottom surface detected by the height detecting portion 195 and the bottom detecting portion, respectively.

Meanwhile, the vial supply device 100 according to the present invention may include an imaging portion (not illustrated) such as a sensor or a camera for checking whether a crack is formed in a vial being supplied.

The imaging portion may obtain surface information of a vial supplied in a lying state on the vial supply portions 130 and 140, a vial placed in a lying state on the vial placing portions 160 and 170, or a vial located in an upright state on the vial discharge portion 150, and the controller may determine whether to recover the vial based on the information obtained by the imaging portion.

When it is determined that a crack is formed in the vial, the controller may move the vial with the crack to a separate recovery space (not illustrated) through a vial moving portion 210 and allow the vial to be recovered.

Meanwhile, based on drug information contained in a drug dispensing request, the controller may selectively operate any one of the first vial supply portion 130 and the second vial supply portion 140 so that a vial to be filled with a drug is selected.

That is, in the present invention, by supplying a vial that satisfies certain conditions based on drug information contained in a drug dispensing request such as a prescription, waste of vials can be prevented, user convenience can be improved, and the efficiency of inventory management of vials can be increased.

Specifically, the controller may compare the number of the first vials V1 remaining in the first vial storage portion 110 and the number of the second vials remaining in the second vial storage portion 120, may select the vials of which a greater number is remaining, and may, based on the selected vials, operate the vial supply portion that corresponds to the selected vials among the first vial supply portion 130 and the second vial supply portion 140.

The number of the first vials V1 remaining in the first vial storage portion 110 may be calculated based on a result of detection by a first vial detecting portion 117 mounted on an inner wall defining an inner space, but the present invention is not necessarily limited thereto.

The number of the second vials remaining in the second vial storage portion 120 may be calculated based on a result of detection by a second vial detecting portion mounted on the inner wall defining the inner space, but the present invention is not necessarily limited thereto.

As described above, the controller may increase the efficiency of inventory management of vials by managing residual amounts of the vials in balance.

Meanwhile, the drug information contained in the drug dispensing request may include information on the total number of drugs that should be added to the vial and information on at least one of the shape, size, volume, hardness, and viscosity of one tablet of the drug.

When allowing vials to be supplied according to a drug dispensing request, the controller may select vials having a volume greater than the total volume corresponding to the total number of drugs and having a small difference from the total volume corresponding to the total number of the drugs and may operate the vial supply portion that corresponds to the selected vials among the first vial supply portion 130 and the second vial supply portion 140.

In addition, the controller may calculate the final volume including voids based on the information on the total volume that corresponds to the total number of tablets of the drug and the information on the shape, size, or volume of one tablet of the drug, may select vials having a volume greater than the final volume and having a small difference from the final volume, and may operate the vial supply portion that corresponds to the selected vials among the first vial supply portion 130 and the second vial supply portion 140.

As described above, the controller may prevent waste of vials by selecting and supplying vials with less empty space left after the vials are completely filled with necessary drugs.

Meanwhile, when the total volume corresponding to the total number of tablets of the drug is greater than a second volume and smaller than a first volume, the controller may operate the second vial supply portion 140 so that a plurality of second vials V2 are discharged to the vial discharge portion 150 or may operate the first vial supply portion 130 so that a single first vial V1 is discharged to the vial discharge portion 150.

Specifically, the controller may calculate the final volume including voids based on the information on the total volume that corresponds to the total number of tablets of the drug and the information on the shape, size, or volume of one tablet of the drug and may, when the final volume is greater than the second volume and smaller than the first volume, operate the second vial supply portion 140 so that a plurality of second vials are discharged to the vial discharge portion 150 or may operate the first vial supply portion 130 so that a single first vial V1 is discharged to the vial discharge portion 150 based on predetermined conditions.

As described above, the controller may increase user convenience by allowing a plurality of relatively small vials to be filled with a drug or a single, relatively large vial to be filled with a drug according to a manager's choice.

Meanwhile, as described above, the first vial detecting portion 117 may detect whether the number of the first vials V1 stored in the first vial storage portion 110 is less than or equal to a predetermined residual number.

The first vial detecting portion 117 will be referred to as “first residual number detecting portion 117” in the description below.

Based on a result detected by the first residual number detecting portion 117, the controller may control whether to perform output on an output portion (not illustrated) in order to refill the first vial storage portion 110 with the first vials V1.

Here, various components such as a light source or a display for a visual output, an alarm means for an auditory output, etc., may be used as the output portion.

When it is detected by the first residual number detecting portion 117 that the number of the first vials V1 stored in a space in the first vial storage portion 110 is less than or equal to a predetermined residual number, the controller may control the output portion and output an alarm for refilling the space in the first vial storage portion 110 with the first vials V1.

Due to the alarm, a user refills the space in the first vial storage portion 110 with the first vials V1.

Meanwhile, when the time during which the number of the stored first vials V1 is determined as less than or equal to the predetermined residual number by the first residual number detecting portion 117 continues for a predetermined second amount of time, the controller may stop the operation of the first vial supply portion 130 and may stop the operation of the first rotating portion 111.

When there is no object detected by the first residual number detecting portion 117 for the predetermined second amount of time, it is determined that no more supply of the first vials V1 is possible, and the operations of the first vial supply portion 130 and the first rotating portion 111 are stopped until the first vial storage portion 110 is refilled with the first vials V1.

Since the principle of detecting the residual number of the second vials is the same as the above-described principle of detecting the residual number of the first vials V1, detailed description thereof will be omitted.

### 3. Drug Dispensing Device

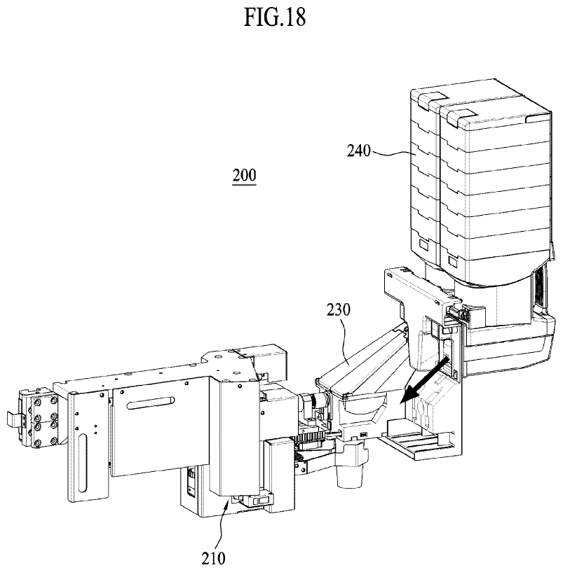

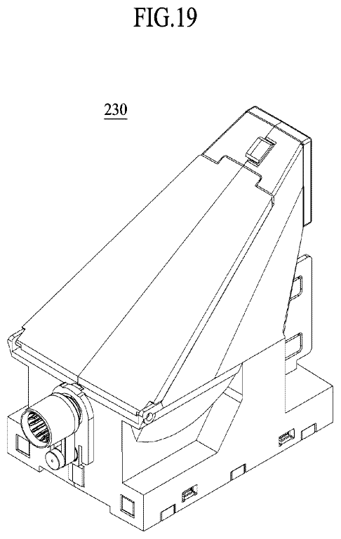

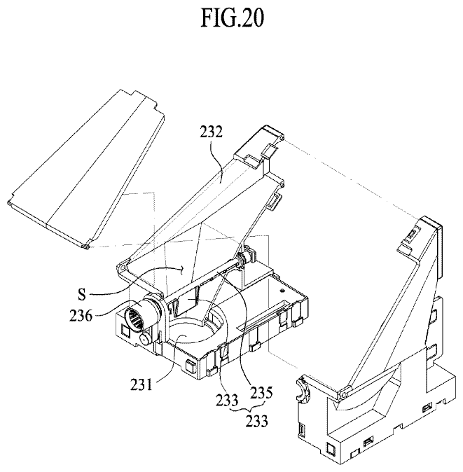

FIG. 18 is a view for describing a drug dispensing device according to the present invention, and FIGS. 19 and 20 are views for describing a drug delivering portion provided in the drug dispensing device according to the present invention.

In addition, FIG. 21 is a view for describing an operating principle of an opening/closing portion and a hitting portion due to a vial moving portion provided in the drug dispensing device according to the present invention.

Referring to FIGS. 18 to 21, the drug dispensing device 200 according to the present invention relates to a device controlling a dispensing principle to vary according to characteristics of a drug that needs to be dispensed to a vial, thereby addressing a problem that a certain drug is not dispensed to a vial.

As described above with reference to FIGS. 4 to 17, when the first vial V1 or the second vial V2 maintains an upright state in the normal state on the vial discharge portion 150 of the vial supply device 100, the first vial V1 or the second vial V2 is gripped by the grip portion 202 of the vial moving portion 210 that is movable along the X, Y, and Z axes.

The first vial V1 or the second vial V2 gripped by the grip portion 202 moves to below a drug delivering portion 230 to which a drug will be dispensed and is filled with the drug through a drug storage portion 240 and the drug delivering portion 230.

The principle with which the first vial V1 or the second vial V2 is filled with a drug will be described in detail below.

The drug dispensing device 200 according to the present invention may include the drug storage portion 240, the drug delivering portion 230, and a controller for controlling whether to discharge a drug.

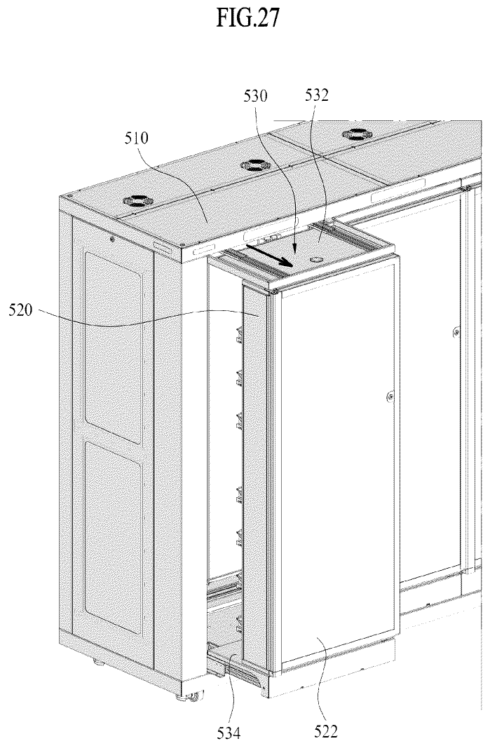

Here, the drug storage portion 240 and the drug delivering portion 230 may be mounted on a mounting frame 520 (see FIGS. 1 and 27) and may be provided by being matched one-to-one with each other.

The drug storage portion 240 may be a type of a drug storage unit or a drug cassette in which a certain drug is stored.

Since components, an operating principle, and the like of the drug storage portion 240 are disclosed in Korean Patent Publication No. 10-2008-0006339, Korean Patent Publication No. 10-2015-0053331, and Korean Patent Publication No. 10-2005-0117425, detailed description thereof will be omitted.

The drug delivering portion 230 may be mounted on the mounting frame 520 to communicate with an outlet of the drug storage portion 240 and may perform a type of a buffer function for drug discharge by receiving a drug from the drug storage portion 240 and allowing the received drug to be discharged to the first vial V1 or the second vial V2, which is a specific space, due to an opening/closing portion 231 that is state-changeable.

When a drug dispensing request such as a prescription of a patient is input to the vial-type drug preparation facility 10 according to the present invention, the drug storage portion 240 from which dispensing of a drug is necessary is selected among a plurality of drug storage portions based on drug information contained in the drug dispensing request, a required number of tablets of the drug is discharged from the selected drug storage portion 240 to the drug delivering portion 230, and the drug delivering portion 230 stores the drug.

Then, due to the movement of the opening/closing portion 231 of the drug delivering portion 230, the drug is added to the first vial V1 or the second vial V2.

Meanwhile, the drug delivering portion 230 may include a main body portion 232 having an inner space S through which the drug received from the drug storage portion 240 passes and a hitting portion 233 for changing the directionality of the drug passing through the inner space S or the drug staying in the inner space S.

The hitting portion 233 may be a component for hitting the drug to prevent a phenomenon in which the drug is not discharged due to sticking to or being caught on an inner wall defining the inner space S.

The hitting portion 233 may have a hitting plate 234 for changing the directionality of the drug and a rotating shaft 235 for rotation of the hitting plate 234.

The hitting portion 233 may rotate in a forward direction or a reverse direction due to the rotation of the rotating shaft 235 in the inner space S or may repeatedly rotate in the forward direction and the reverse direction.

The hitting portion 233 may rotate due to a second external force applying portion 206 of the vial moving portion 210 which will be described below.

The drug delivering portion 230 may further include a guide portion 236 connected to the hitting portion 233 to guide the hitting portion 233 to be located in a predetermined state and prevent a change in the position of the hitting portion 233 due to the drug staying in the inner space S.

The guide portion 236 may be detachably connected to the rotating shaft 235 by magnetism and may return to a specific position due to its own weight, thereby guiding the hitting plate 234 to be located in the predetermined state.

Here, the specific position may be a direction in which a weight of the guide portion 236 faces the ground, and the predetermined state may be a state in which the hitting plate 234 stands upright.

As described above, in the case in which the drug is delivered from the drug storage portion 240 to the inner space S and stays in the inner space S, even when the position of the hitting plate 234 changes due to impact caused by the drug, that is, even when the hitting plate 234 rotates, the hitting plate 234 returns to the predetermined state due to the guide portion 236 returning to the specific position.

The returning of the hitting plate 234 may enable dispersion of tablets of the drug in the inner space S and may prevent a phenomenon in which the tablets of the drug are concentrated and gathered at a specific space in the inner space S.

The movement of the opening/closing portion 231 for discharging a drug from the drug delivering portion 230 to the vial V providing a specific space may be implemented by a first external force applying portion 204 of the vial moving portion 210.

The vial moving portion 210 may include the grip portion 202 for gripping the vial V located in an upright state on the vial discharge portion 150, the first external force applying portion 204 for the movement of the opening/closing portion 231, and the second external force applying portion 206 for the operation of the hitting portion 233.

The interval of the grip portion 202 may change due to a driving force of a first driving motor 208, and as a result, the vial V located on the vial discharge portion 150 may be gripped and may be moved to below the drug delivering portion 230 for discharging a drug.

The first external force applying portion 204 may be a component that moves to change the state of the opening/closing portion 231 and allow an outlet of the drug delivering portion 230 to be open in a case in which the grip portion 202 for gripping the vial V defining a specific space is moved and an inlet of the vial V is located below the outlet of the drug delivering portion 230.

The first external force applying portion 204 may move forward based on the grip portion 202 due to a driving force of a second driving motor 212 and may be formed in a rod shape.

When the first external force applying portion 204 moves forward, the opening/closing portion 231 is pressed and pushed rearward, and the outlet is open.

Here, when the first external force applying portion 204 returns to its original position, the opening/closing portion 231 returns to its original position due to a restoration force of an elastic portion (not illustrated), and the outlet is closed.

When the first external force applying portion 204 moves, the second external force applying portion 206 may operate the hitting portion 233 together with the first external force applying portion 204.

When the second external force applying portion 206 moves forward, the second external force applying portion 206 is engaged with the guide portion 236 of the hitting portion 233, and then the hitting portion 233 rotates due to a driving force of a third driving motor 214.

Meanwhile, the time during which the outlet is open due to the first external force applying portion 204 may be preset based on various criteria.

For example, the time during which the outlet provided by the opening/closing portion 231 being pushed rearward as the first external force applying portion 204 moves forward based on the grip portion 202 is open may be preset as a predetermined opening time regardless of the drug storage portion 240, the type of drug, and the like.

In this case, a situation may occur in which the first external force applying portion 204 returns to its original position and the outlet is closed even when the drug stored in the drug storage portion 240 has not been completely discharged to the vial through the outlet.

The above situation is due to characteristics of the drug, that is, characteristics such as the shape, size, volume, hardness, and/or viscosity of one tablet of the drug, and the likelihood of the situation increases in a case in which the size or volume of one tablet of the drug is relatively large or the viscosity of the drug is relatively high.

In the case in which the size or volume of one tablet of the drug is relatively large, since there is a possibility that the tablets of the drug may be gathered together in the inner space despite the presence of the hitting portion 233, a situation in which the tablets of the drug are not able to be discharged through the outlet within the predetermined time may occur.

In addition, in the case in which the viscosity of the drug is relatively high as with omega-3, tablets of the drug may remain stuck to each other or may stick to the inner wall defining the inner space S, the hitting portion 233, the opening/closing portion 231, or the like despite the presence of the hitting portion 233, and a situation in which the tablets of the drug are not able to be discharged through the outlet within the predetermined time may occur.

In order to provide against the above-described situation in which tablets of a certain drug are not able to be discharged through the outlet within the predetermined opening time, the drug dispensing device 200 according to the present invention may include a non-discharge detecting portion (not illustrated) that is a type of sensor.

The non-discharge detecting portion is a sensor located in the inner space S to detect whether a drug remain on an upper surface of the opening/closing portion 231 and/or in the inner space S and may be provided as a single non-discharge detecting portion or a plurality of non-discharge detecting portions.

The non-discharge detecting portion may be activated at a point in time at which the first external force applying portion 204 begins to move rearward to its original position to close the outlet after moving forward or at a later point in time.

The later point in time may be a point in time at which the rearward movement of the first external force applying portion 204 is complete.

Here, when it is detected by the non-discharge detecting portion that a drug remain on the upper surface of the opening/closing portion 231 or in the inner space S after the non-discharge detecting portion is activated, the controller may cause the first external force applying portion 204 to move forward again to re-open the outlet.

In this case, since the second external force applying portion 206 also moves forward again, the hitting portion 233 rotates again, and smooth drug discharge is possible.

The time during which the outlet is re-opened due to the first external force applying portion 204 may be the same as the predetermined opening time, but the present invention is not necessarily limited thereto, and the time during which the outlet is re-opened due to the first external force applying portion 204 may be set to until a point in time at which no object is detected by the non-discharge detecting portion.

Meanwhile, the non-discharge detecting portion may be activated at a point in time at which the first external force applying portion 204 begins to move forward or a point in time at which the forward movement of the first external force applying portion 204 is complete.

In this case, the time during which the outlet is open due to the first external force applying portion 204 may be set to until a point in time at which no object is detected by the non-discharge detecting portion, and a situation in which re-opening of the outlet is necessary may be prevented from occurring.

In the above, the operation in which the drug storage portion 240 from which dispensing of a drug is necessary is selected based on the drug information contained in the drug dispensing request, a required number of tablets of the drug is discharged from the selected drug storage portion 240 to the drug delivering portion 230, the tablets of the drug are temporarily stored in the drug delivering portion 230, and the drug delivering portion 230 allows the tablets of the drug to be discharged to the vial V to fill the vial V with the tablets of the drug has been described.

That is, before the vial V is moved, a plurality of drug delivering portions 230 may already have drugs stored therein based on a drug dispensing request.

However, in the drug dispensing device 200 according to the present invention, the controller may, based on drug information contained in the drug dispensing request, control a point in time at which a drug is dispensed from the drug storage portion 240 and a point in time at which the state of the opening/closing portion 231 is changed, and this will be described in detail below.

The controller may control whether to discharge a drug from the drug storage portion 240 and the drug delivering portion 230, may determine whether the drug satisfies a first condition or a second condition based on the drug information, and may, based on a result of the determination, control the point in time at which the drug is dispensed from the drug storage portion 240 and the point in time at which the state of the opening/closing portion 231 is changed.

Here, the drug information may include drug information on at least one of the shape, size, volume, hardness, and viscosity of one tablet of the drug.

In a case in which the drug information is smaller than or equal to a predetermined reference value, the controller may control the point in time at which the drug is dispensed from the drug storage portion 240 and the point in time at which the state of the opening/closing portion 231 is changed to be different from each other.

In the case in which the drug information is smaller than or equal to a predetermined reference value, the controller may control the point in time at which the drug is dispensed to be earlier than the point in time at which the state of the opening/closing portion 231 is changed so that the drug stays in the drug delivering portion 230 for a predetermined amount of time and then is discharged to the vial V providing a specific space.

Specifically, the drug information may include information on the size or volume of one tablet of the drug, and in the case in which the drug information is smaller than or equal to a predetermined reference value, the controller may control the point in time at which the drug is dispensed to be earlier than the point in time at which the state of the opening/closing portion 231 is changed so that the drug stays in the drug delivering portion 230 for a predetermined amount of time and then is discharged to the specific space.

The above operating principle can be applied to a situation in which the size or volume of one tablet of the drug is small and thus there is no problem in discharge because the drug is not caught on the inner wall even when discharged through the outlet of the drug delivering portion 230 after staying in the drug delivering portion 230 for a predetermined amount of time.

On the other hand, in a case in which the drug information exceeds a predetermined reference value, the controller may control the point in time at which the drug is dispensed and the point in time at which the state of the opening/closing portion is changed to be synchronized with each other so that the drug discharged from the drug storage portion 240 is immediately discharged to the vial V providing the specific space after passing through the drug delivering portion 230.

This is because, when the drug stays in the drug delivering portion 230 for a predetermined amount of time in the case in which the size or volume of one tablet of the drug is relatively large, there is a possibility of a problem in which, despite the presence of the hitting portion 233, tablets of the drug may be gathered together and not be discharged due to being caught on the inner wall when a discharge process is performed afterwards.

In addition, the drug information may include information on the viscosity of the drug, the controller may control the point in time at which the drug is dispensed to be earlier than the point in time at which the state of the opening/closing portion 231 is changed in the case in which the information on the viscosity is lower than or equal to a predetermined reference value, and the controller may control the point in time at which the drug is dispensed and the point in time at which the state of the opening/closing portion is changed to be synchronized with each other in the case in which the information on the viscosity exceeds the predetermined reference value.

The viscosity is a factor that determines a degree to which a drug stick to each other, and when a drug having a high viscosity, such as omega-3, stay in the drug delivering portion 230 for a predetermined amount of time, since there is a possibility of a problem in which, despite the presence of the hitting portion 233, the tablets of the drug may not be discharged afterwards due to remaining stuck to each other or sticking to the hitting portion 233 or the opening/closing portion 231, it is necessary to synchronize the point in time at which the drug is dispensed and the point in time at which the state of the opening/closing portion is changed.

Therefore, in the present invention, by differently controlling whether to allow a drug to stay in the drug delivering portion 230 according to characteristics of a drug to be dispensed to a vial, that is, the size, volume, or the like of one tablet of the drug, the possibility that a certain drug may not be dispensed to a vial can be prevented.

Meanwhile, in the case in which the point in time at which the drug is dispensed and the point in time at which the state of the opening/closing portion is changed are synchronized, all of the above-described methods may apply to the non-discharge detecting portion and the first external force applying portion 204 within a non-contradictory range.

### 4. Drug Fill Amount Inspection Device

FIG. 22 is a view for describing a drug fill amount inspection device according to the present invention.

When a drug is dispensed and the vial V is filled with the drug by the drug dispensing device 200 as described above, the vial V filled with the drug is gripped by the grip portion 202 and moved to a drug fill amount inspection device 600.

Referring to FIG. 22, the drug fill amount inspection device 600 according to the present invention may include a mirror portion 610, an imaging portion 620, an image storage portion (not illustrated), and the like.

The mirror portion 610 may be a known mirror that can reflect a side surface of the vial V filled with the drug when the vial V filled with the drug is gripped by the grip portion 202 of the vial moving portion 210 and placed in an upright state on an imaging standby portion 630 having a plate shape.

The imaging portion 620 may be a type of camera located on an upper side of the vial V filled with the drug in the upright state in order to capture an image of a lower side of the vial V filled with the drug.

The image storage portion may be a type of storage means such as a memory for storing an image captured by the imaging portion 620.

The mirror portion 610 may be disposed to be inclined upward, in other words, disposed so that a horizontal distance from the vial V filled with the drug increases upward.

The imaging portion 620 may be disposed at a position that allows the mirror portion 610 to be in an imaging range, that is, within a viewing angle, and thus, an image of the mirror portion 610 may be simultaneously captured when the imaging portion 620 captures the image of the lower side.

Here, the imaging portion 620 may capture an image of a reflective surface of the mirror portion 610 because the mirror portion 610 is disposed to be inclined, and an image captured by the imaging portion 620 may simultaneously include an image of the upper side of the vial V filled with the drug and an image of the side surface of the vial V filled with the drug that is reflected on the reflective surface of the mirror portion 610.

Meanwhile, the controller may store the image captured by the imaging portion 620 as it is in the image storage portion or may store a processed image of the captured image in the image storage portion.

Of course, the controller may store both the captured image and the processed image in the image storage portion.

The processing may be a type of image processing in which at least one of a reference line and an actual line is marked on the captured image by the controller.

The reference line may be a virtual line at an uppermost end in a state in which filling of the vial V with the drug is complete based on at least one of the type of drug with which the vial V should be filled, volume information on one tablet of the drug or all tablets of the drug with which the vial V should be filled, the number of tablets of the drug with which the vial V should be filled, and information on voids formed when the vial V is filled with drugs.

The actual line may be an actual line at the uppermost end in the state in which the vial V is filled with the drug based on the image of the side surface of the vial V filled with the drug.

The controller may, based on the drug information based on the drug dispensing request, set a virtual reference line by assuming that the filling of the vial V with the drug is complete, may process the image captured by the imaging portion 620 so that the reference line is marked on the captured image, and then may store the processed image in the image storage portion.

In addition, the controller may extract an actual line at which the vial V is filled with the drug based on the image of the side surface of the vial V filled with the drug, may process the captured image so that the actual line is marked on the captured image, and then may store the processed image in the image storage portion.

Here, the controller may compare the reference line and the actual line and may, based on a result of the comparison, determine whether the vial V is filled with a correct amount of the drug.

In other words, the controller may calculate a size of a space between the reference line and the actual line based on the reference line and the actual line, may calculate the number of tablets of the drug that corresponds to the size of the space based on the calculated size of the space, and then may calculate an error based on the correct amount.

Meanwhile, the drug fill amount inspection device 600 according to the present invention may include an output portion for outputting information on the vial filled with the drug.

The display 12 illustrated in FIG. 1 or a separate display or speaker may be provided as the output portion, and the information on the vial V filled with the drug may be the processed image or information on the error calculated based on the correct amount of the drug with which the vial V should be filled.

Of course, the information on the vial V filled with the drug may include both the processed image and the information on the calculated error.

When an image of the vial V filled with the drug placed on the imaging standby portion 630 is captured by the imaging portion 620 in order to obtain the information on the vial V filled with the drug as described above, the vial V filled with the drug is moved to a position for labeling by a vial pushing portion 640 (see FIG. 23).

By the labeling device 300, a label on which information related to the drug dispensing request is printed is attached to an outer surface of the vial V filled with the drug moved to the position for labeling.

When the label is attached to the vial V by the labeling device 300, the vial V to which the label is attached is moved to a drug-filled vial discharge device 400 by a vial transporting portion 310 that is movable along the X, Y, and Z axes.

Meanwhile, it has been described above that the image captured by the imaging portion 620 simultaneously includes the image of the upper side of the vial V filled with the drug and the image of the side surface of the vial V filled with the drug that is reflected on the reflective surface of the mirror portion 610.

The image of the side surface of the vial V filled with the drug may include an image of the entire side surface, and to this end, the vial V filled with the drug may be rotated on the imaging standby portion 630.

In order to obtain the image of the entire side surface of the vial V filled with the drug, a plurality of mirror portions 610 may be radially disposed, or the mirror portion 610 may be formed in a radial donut shape or may rotate in the circumferential direction based on the vial V filled with the drug, but the present invention is not necessarily limited thereto.

The controller may check whether a crack is formed in the vial V filled with the drug based on the images of the upper side and the side surface of the vial V filled with the drug.

When it is determined that a crack is formed in the vial V filled with the drug, the controller may operate the vial moving portion 210 to move and recover the vial V filled with the drug to a recovery space (not illustrated) that is different from the drug-filled vial discharge device 400.

### 5. Drug-Filled Vial Discharge Device

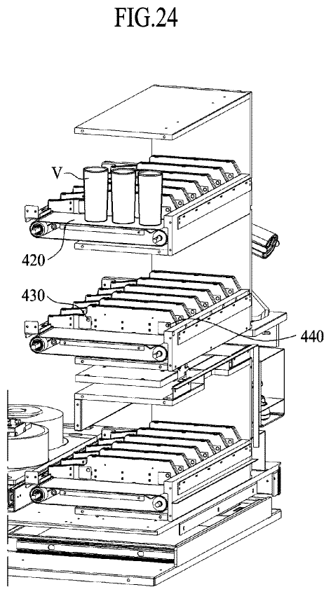

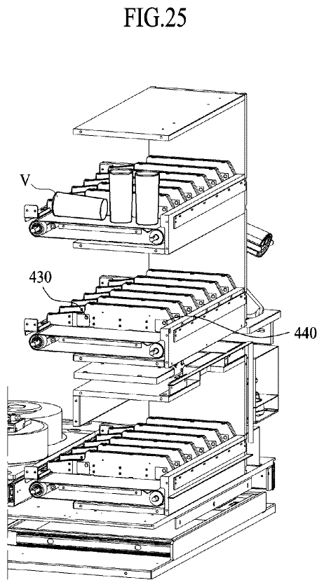

FIG. 23 is a view for describing a labeling device and a drug-filled vial discharge device according to the present invention, and FIGS. 24 and 25 are views for describing a detecting portion provided in the drug-filled vial discharge device according to the present invention.

Referring to FIGS. 23 to 25, the drug-filled vial discharge device 400 according to the present invention may be a device that enables a vial V filled with a drug to be withdrawn to the outside by a manager such as a pharmacist after the vial V is filled with the drug by the drug dispensing device 200 described above with reference to FIGS. 18 to 21, and then an image of the drug-filled vial V is obtained by the drug fill amount inspection device 600 described above with reference to FIG. 22.

The drug-filled vial discharge device 400 according to the present invention may be formed of a plurality of layers, and each layer may be divided into a plurality of columns.

For example, the drug-filled vial discharge device 400 according to the present invention may be formed of three layers and six columns.

The drug-filled vial discharge device 400 may include a belt portion 420, a first detecting portion 430, and the like.

The belt portion 420 is a component for moving the drug-filled vial V that is placed by the vial transporting portion 310 toward an outlet for withdrawal to the outside, and the belt portion 420 may be driven by a driving force of a fourth driving motor 450.

The belt portion 420 may operate independently for each layer.

In addition, a single belt portion 420 or a plurality of belt portions 420 may be applied for a plurality of columns provided in the same layer, and the plurality of belt portions 420 may operate simultaneously with each other, but the present invention is not necessarily limited thereto.

The first detecting portion 430 may be a type of photosensor for detecting whether the drug-filled vial V is present at a first position on the belt portion 420, but the present invention is not necessarily limited thereto.

The first position may be a position leaned toward the rear on the belt portion 420, and specifically, in a case in which the drug-filled vial V is sequentially located in the normal state from the foremost portion toward the rear, the first position may be a position at which the drug-filled vial V is not present.

Therefore, based on a result detected by the first detecting portion 430, the controller determines whether the drug-filled vial V located on the belt portion 420 is present in an abnormal state.

When it is detected by the first detecting portion 430 that the drug-filled vial V is present at the first position, based on the detected result, the controller determines that the drug-filled vial V is in the abnormal state, which is a state in which the drug-filled vial V is lying on the belt portion 420.

Although an object detected by the first detecting portion 430 should not be present in the case in which the drug-filled vial V is upright in the normal state on the belt portion 420, if an object of detection is present, since this is a case in which the drug-filled vial V has fallen as illustrated in FIG. 25, the controller determines this state as the abnormal state.

To sum up, the controller may allow a predetermined number or less of drug-filled vials V to be located in the normal state from the foremost portion toward the rear on the belt portion 420, and in the case in which the predetermined number of drug-filled vials V are located from the foremost portion on the belt portion 420, the first detecting portion 430 is provided at a position where an object of detection is not present.

Thus, when it is determined by the first detecting portion 430 that an object of detection is present, the controller determines that the drug-filled vial V is lying due to a nonideal factor.

Meanwhile, the first detecting portion 430 is activated at a point in time when a predetermined amount of time has elapsed after the drug-filled vial V is placed on the belt portion 420, and detects whether the drug-filled vial V is present at the first position.

The predetermined amount of time may be set in consideration of the time during which the drug-filled vial V is moved toward the foremost portion on the belt portion 420 when the drug-filled vial V is placed on the belt portion 420 and the time required for the predetermined number of drug-filled vials V to be located from the foremost portion on the belt portion 420.

The predetermined amount of time may be set based on a point in time at which the belt portion 420 operates after the drug-filled vial V is placed on the belt portion 420.

The drug-filled vial discharge device 400 according to the present invention may further include a second detecting portion 440 in addition to the first detecting portion 430.

The second detecting portion 440 may be a type of photosensor for detecting whether the drug-filled vial V placed on the belt portion 420 is located at a second position after passing through the first position.

Here, the second position may be a position for detecting whether the drug-filled vial V is located at the foremost portion on the belt portion 420 that is for the withdrawal of the drug-filled vial V to the outside.

That is, the second detecting portion 440 is able to detect whether the drug-filled vial V is present at the foremost position on the belt portion 420 for the withdrawal to the outside.

When it is detected by the second detecting portion 440 that the drug-filled vial V is located at the second position, the controller may determine that the drug-filled vial V is located at the foremost portion on the belt portion 420 and may, based on the result detected by the second detecting portion 440, activate the first detecting portion 430 at a point in time when the predetermined amount of time has elapsed.

At this time, when the drug-filled vial V is detected by the second detecting portion 440, the controller may control the fourth driving motor 450 to stop the operation of the belt portion 420 and then may re-operate the belt portion 420 when a new drug-filled vial V is placed on the belt portion 420.

Meanwhile, the drug-filled vial discharge device 400 according to the present invention may include the display portion 402 for notifying a manager of the withdrawal of the drug-filled vial V to the outside when it is detected by the second detecting portion 440 that the drug-filled vial V is located at the second position.

The display portion 402 may be a type of optical component such as an LED, and when the manager checks drug information according to an image of the vial V to be withdrawn or an image of a drug that is displayed on the display 12 and adds an input relating thereto, the LED may emit light to expose the position of the vial V to the manager.

Of course, when the drug-filled vial V is moved to the foremost portion on the belt portion 420 and detected by the second detecting portion 440, the display portion 402 may immediately emit light to expose the position of the vial V the needs to be withdrawn to the manager.

### 6. Frame Part Rotation Device for Maintenance

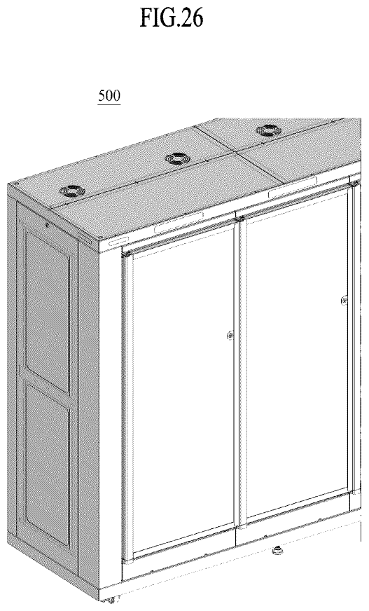

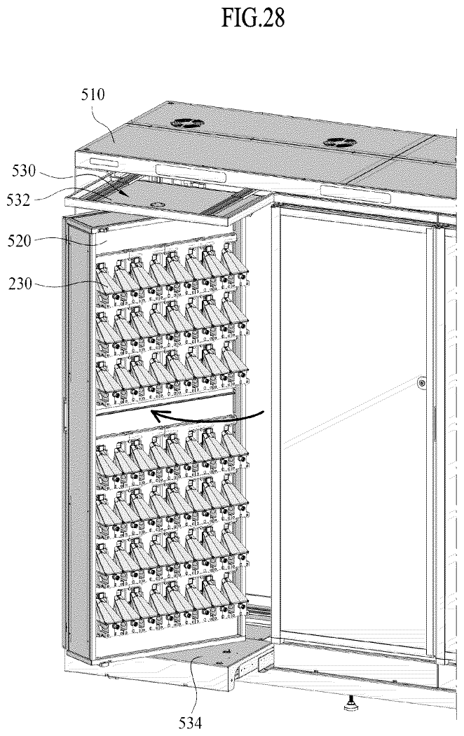

FIG. 26 is a view for describing a frame part rotation device for maintenance according to the present invention, and FIGS. 27 and 28 are views for describing a rotating operation of a mounting frame part provided in the frame part rotation device for maintenance according to the present invention.

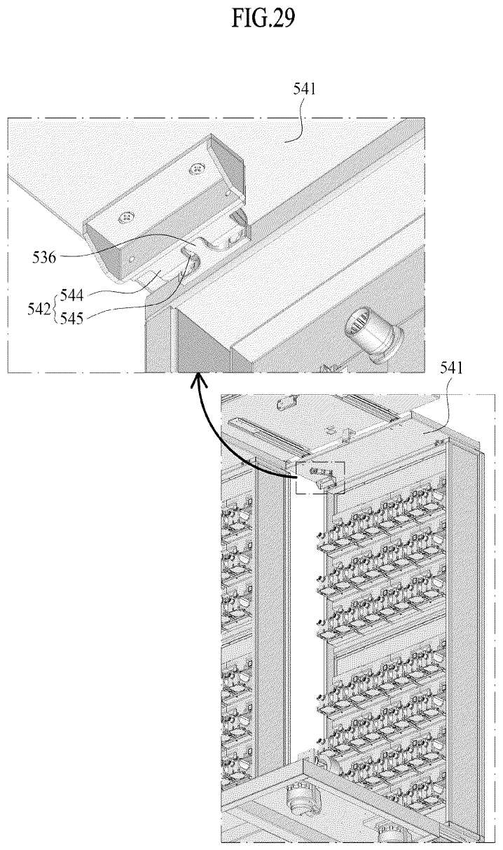

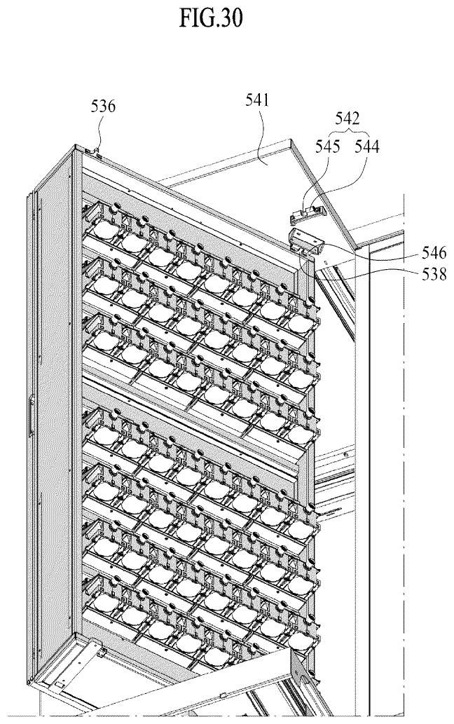

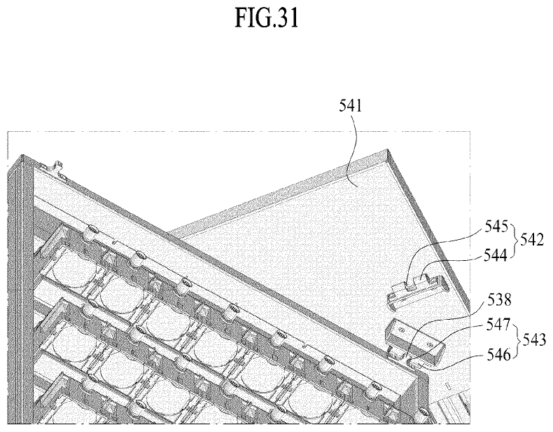

In addition, FIG. 29 is a view for describing a coupling relationship between a first catching portion and a first protruding portion provided in the frame part rotation device for maintenance according to the present invention, and FIGS. 30 and 31 are views for describing a coupling relationship between a second catching portion and a second protruding portion provided in the frame part rotation device for maintenance according to the present invention.

Referring to FIGS. 26 to 31, the frame part rotation device for maintenance 500 according to the present invention may be a device that implements optimization of rotation of a mounting frame part 520 to facilitate maintenance for components storing a drug and dispensing the stored drug.

Here, the components storing a drug and dispensing the stored drug may be the drug dispensing portions 230 and 240 including the drug storage portion 240 and the drug delivering portion 230 described above with reference to FIGS. 18 to 21, but preferably, the component may be the drug delivering portion 230.

The frame part rotation device for maintenance 500 may include the drug dispensing portions 230 and 240, the mounting frame part 520, and a support frame part 530.

The drug dispensing portions 230 and 240 may store a drug and discharge the stored drug to the specific space provided by the vial V and may include the drug storage portion 240 and the drug delivering portion 230 as described above.

The mounting frame part 520 is a frame that allows the drug dispensing portions 230 and 240 to be mounted on predetermined positions, the drug storage portion 240 may be mounted on an outer side (front side) of the mounting frame part 520, and the drug delivering portion 230 may be mounted on an inner side (rear side) of the mounting frame part 520.

A door part 522 may be rotatably mounted on the front side of the mounting frame part 520, and due to the rotation of the door part 522, the outer side (front side) of the mounting frame part 520 may be exposed to the outside, and maintenance of the drug storage portion 240 by the manager may be possible.

The support frame part 530 may be a frame that supports the mounting frame part 520 to be rotatable and enables the mounting frame part 520 to be withdrawn from a main frame part 510.

Here, the main frame part 510 may be a frame that constitutes an exterior of the vial-type drug preparation facility 10 according to the present invention.

The support frame part 530 may include an upper support frame part 532 and a lower support frame part 534 located on an upper side and a lower side, respectively, of the mounting frame part 520.

In a state in which the support frame part 530 is inserted into the main frame part 510, the mounting frame part 520 may be located in a first state on the support frame part 530 and may enable the drug to be dispensed from the drug dispensing portions 230 and 240 to the specific space provided by the vial V.

The first state may be a state in which the inner side of the mounting frame part 520 is located in an inner space provided by the main frame part 510 and enables dispensing of the drug from the drug dispensing portions 230 and 240 in the inner space.

The mounting frame part 520 may be changed from the first state to a second state by rotating in a state in which the support frame part 530 is withdrawn from the main frame part 510 and may enable maintenance of the drug dispensing portions 230 and 240.

The second state may be a state in which the inner side of the mounting frame part 520 is exposed to the outside and enables maintenance of the drug delivering portion 230 of the drug dispensing portions 230 and 240 that is located on the inner side of the mounting frame part 520.

The support frame part 530 may include a support plate part 541, a first catching portion 542, and a second catching portion 543.

The support plate part 541 may be formed in the shape of a plate having a predetermined size and may provide a rotating shaft of the mounting frame part 520.

The first catching portion 542 may be mounted on the support plate part 541 so that the mounting frame part 520 is caught and the first state is maintained.

The second catching portion 543 may be mounted on the support plate part 541 so that the mounting frame part 520 is caught and the second state is maintained in a case in which the mounting frame part 520 is rotated in a second direction, which is a direction opposite to a first direction in which the mounting frame part 520 is caught at the first catching portion 542 based on the support plate part 541, and is changed to the second state.

Here, the first catching portion 542 and the second catching portion 543 may be mounted on the support plate part 541 of the upper support frame part 532, but the present invention is not necessarily limited thereto, and the first catching portion 542 and the second catching portion 543 may be mounted on the support plate part of the lower support frame part 534.

The second catching portion 543 may be located behind the first catching portion 542 based on the first catching portion 542 when viewed from an upper side and may be mounted on an arbitrary position on a circumference relative to the rotating shaft.

The second catching portion 543 may enable the mounting frame part 520 to rotate within a range of less than 180° on the support plate part 541.

As described above, the frame part rotation device for maintenance 500 according to the present invention may rotate the door part 522 based on the mounting frame part 520 so that the outer side (front side) of the mounting frame part 520 is exposed to the outside in a case in which maintenance of the drug storage portion 240 of the drug dispensing portions 230 and 240 is necessary.

In addition, the support frame part 530 may be withdrawn based on the main frame part 510, and then the mounting frame part 520 may be rotated in the second direction so that the inner side (rear side) of the mounting frame part 520 is exposed to the outside in a case in which maintenance of the drug delivering portion 230 of the drug dispensing portions 230 and 240 is necessary.

Meanwhile, the mounting frame part 520 may have a first protruding portion 536 inserted into the first catching portion 542 to maintain the first state by being engaged with the first catching portion 542.

The first protruding portion 536 may be formed on one side of an upper end of an inner side of the mounting frame part 520.

The first catching portion 542 may have a first fixing portion 544 having a first insertion space for insertion of the first protruding portion 536 and a first variable portion 545 for pressing the first protruding portion 536 by returning to its original position when the insertion is complete after moving backward due to contact with the first protruding portion 536 in a process in which the first protruding portion 536 is inserted into the first insertion space.

In addition, the mounting frame part 520 may have a second protruding portion 538 located apart from the first protruding portion 536 and inserted into the second catching portion 543 to maintain the second state by being engaged with the second catching portion 543.

The second catching portion 543 may have a second fixing portion 546 having a second insertion space for insertion of the second protruding portion 538 and a second variable portion 547 for pressing the second protruding portion 538 by returning to its original position when the insertion is complete after moving backward due to contact with the second protruding portion 538 in a process in which the second protruding portion 538 is inserted into the second insertion space.

As described above, the frame part rotation device for maintenance 500 according to the present invention may enable stable drug dispensing by maintaining the first state by an interaction between the first catching portion 542 and the first protruding portion 536 mounted on the mounting frame part 520.

In addition, in the process in which the support frame part 530 is withdrawn from the main frame part 510 and the mounting frame part 520 is rotated based on the support frame part 530, the second state may be maintained due to an interaction between the second catching portion 543 and the second protruding portion 538 mounted on the mounting frame part 520 so that maintenance of the drug delivering portion 230 or the like located inside is possible.

The configurations and features of the present invention have been described above based on the embodiments according to the present invention, but the present invention is not limited thereto, it is obvious to those skilled in the art to which the present invention pertains that various changes or modifications are possible within the spirit and scope of the present invention, and therefore, it should be noted that such changes or modifications belong to the scope of the appended claims.

1. A vial supply device comprising:
a vial placing portion where a vial is placed in a lying state;
a vial discharge portion moving the vial to a subsequent process for filling the vial with a drug; and
a vial pressing portion pressing the vial placed on the vial placing portion to cause the vial to fall onto the vial discharge portion while in an upright state.

2. The vial supply device of claim 1, wherein:
the vial placing portion has a first vial placing portion where a first vial is placed in a lying state after moving through a first path and a second vial placing portion where a second vial is placed in a lying state after moving through a second path; and
the first vial placing portion and the second vial placing portion are located so that a falling space is provided therebetween to allow the first vial or the second vial to fall in an upright state due to the vial pressing portion in a process of moving in the lying state.

3. The vial supply device of claim 2, further comprising a space opening/closing portion for adjusting opening/closing of the falling space by moving.

4. The vial supply device of claim 3, wherein:
the vial pressing portion has a first vial pressing portion for pressing the first vial placed on the first vial placing portion and a second vial pressing portion for pressing the second vial placed on the second vial placing portion; and
movement ranges of the first vial pressing portion and the second vial pressing portion are adjusted based on the lying states of the first vial and the second vial.

5. The vial supply device of claim 4, wherein, in a case in which an inlet of the first vial is located in a direction toward the second vial pressing portion on the first vial placing portion, the first vial pressing portion presses the first vial so that the first vial is located on the second vial placing portion past the falling space in a state in which the falling space is closed by the space opening/closing portion.

6. The vial supply device of claim 5, wherein the second vial pressing portion presses the first vial and allows the first vial to be located upright in a normal state on the vial discharge portion through the falling space in a state in which the falling space is open.

7. The vial supply device of claim 4, wherein, in a case in which the inlet of the first vial is located in a direction toward the first vial pressing portion on the first vial placing portion, the first vial pressing portion presses the first vial and allows the first vial to be located upright in the normal state on the vial discharge portion through the falling space in the state in which the falling space is open.

8. The vial supply device of claim 4, further comprising:
a first vial inlet detecting portion for detecting a direction of the inlet of the first vial placed on the first vial placing portion; and
a second vial inlet detecting portion for detecting a direction of the inlet of the second vial placed on the second vial placing portion.

9. The vial supply device of claim 4, further comprising:
a first vial uprightness maintaining portion and a second vial uprightness maintaining portion moved together with the first vial pressing portion and the second vial pressing portion, respectively, so that, in a process in which the first vial or the second vial falls onto the vial discharge portion through the falling space while in an upright state, a space in which falling is possible is defined and the upright state is maintained.

10. The vial supply device of claim 9, wherein the vial discharge portion moves to be close to the falling space and prevents the first vial or the second vial from lying in a case in which the first vial or the second vial falls and moves downward and returns to its original position so that the first vial or the second vial moves to a subsequent process when falling of the first vial or the second vial is complete.

11. The vial supply device of claim 10, further comprising at least one vial detecting portion for detecting at least one of a height and an area of a bottom surface of the first vial or the second vial when the first vial or the second vial is located in an upright state on the vial discharge portion.
